(19) United States
(12) Patent Application Publication
(10) Pub. No.: US 2010/0242469 A1
(43) Pub. Date: Sep. 30, 2010

(54) BRAKE ACTUATING UNIT

(75) Inventors: Johann Jungbecker, Badenheim (DE); Steffen Linkenbach, Eschborn (DE); Ronald Bayer, Muhlheim/Main (DE); Jürgen Böhm, Oberneisen (DE); Wolfgang Ritter, Oberursel/Ts. (DE); Holger von Hayn, Bad Vilbel (DE); Jens Bacher, Frankfurt am Main (DE); Uwe Bach, Niedernhausen (DE); Michael Vogt, Simmern (DE); Manfred Rüffer, Sulzbach (DE)

Correspondence Address: RATNERPRESTIA, P.O. BOX 980, VALLEY FORGE, PA, 19482, US

(73) Assignee: Continental Teves AG & Co.oHG, Frankfurt (DE)

(21) Appl. No.: 12/744,403

(22) PCT Filed: Oct. 29, 2008
(86) PCT No.: PCT/EP08/64663

§ 371 Date: May 24, 2010

(30) Foreign Application Priority Data
Nov. 27, 2007 (DE) 10 2007 057 041.6
Aug. 19, 2008 (DE) 10 2008 038 320.1

(51) Int. Cl. F15B 7/08

(52) U.S. Cl. 60/594

(57) ABSTRACT

A brake actuating unit for motor vehicles includes a brake master cylinder, a booster stage which is connected in front of the brake master cylinder, and a drive unit for driving the booster stage. In order to make comfortable braking operations possible, there is provision for the transmission both of the actuating force and of the boosting force to the primary piston of the brake master cylinder to take place by a force transmission module which has at least one elastic element and is arranged in the primary piston.

### CROSS REFERENCE TO RELATED APPLICATIONS

This application is the U.S. national phase application of PCT International Application No. PCT/EP2008/064663, filed Oct. 29, 2008, which claims priority to German Patent Application No. 10 2007 057 041.6, filed Nov. 27, 2007 and German Patent Application No. 10 2008 038 320.1, filed Aug. 19, 2008, the contents of such applications being incorporated by reference herein.

### FIELD OF THE INVENTION

The present invention relates to a brake actuating unit, comprising a brake master cylinder which can be actuated by means of a brake pedal and to which wheel brakes of a motor vehicle are connected, a booster stage which is connected in front of the brake master cylinder, and a drive unit for driving the booster stage, which drive unit is formed by an electric motor, a piston rod for transmitting an actuating force being provided between the brake pedal and a primary piston of the brake master cylinder, and the booster stage being arranged in a booster housing and having a first step-down gear mechanism which is formed by a ball screw drive, the threaded nut of which is driven by the electric motor via a second step-down gear mechanism and the threaded spindle of which transmits the boosting force which is generated by the booster stage to the primary piston.

### BACKGROUND OF THE INVENTION

A brake actuating unit of this type is known, for example, from DE 199 39 950 A1, which is incorporated by reference. The brake master cylinder and the booster stage with its electromechanical drive form a pressure generator which generates a brake pressure which corresponds to a sum of an actuating force which is produced by the vehicle driver and a booster force which is generated by the booster stage. The special features of the previously known brake actuating unit are, inter alia, an input sensor for detecting the actuating force which is produced by a driver and a control unit which actuates the electromechanical drive of the booster stage as a function of signals which are supplied by the input sensor.

In the previously known brake actuating unit, the type of the transmission of the forces between a push rod which is actuated by the driver and an output element of the booster stage is considered to be disadvantageous, which transmission takes place by direct mechanical contact of the said components. A considerable impairment in the driving comfort results, in particular in the case of relatively heavy braking operations, from the mentioned mechanical stop of the piston rod and the threaded spindle on the primary piston of the brake master cylinder.

### SUMMARY OF THE INVENTION

It is therefore an object of the present invention to propose a brake actuating unit of the generic type mentioned in the introduction, by way of which a high degree of comfort can be achieved, in particular in the case of great actuating forces and associated braking operations.

### BRIEF DESCRIPTION OF THE DRAWINGS

Further features and advantages of the invention result from the following description of two preferred exemplary embodiments in conjunction with the appended drawing. Those parts of the two design variants which correspond to one another or are identical are denoted by the same reference numerals. In the drawing:

FIG. 1 shows a longitudinal section of a first embodiment of the subject matter of the invention,

FIG. 2 shows a simplified longitudinal section of a second embodiment of the subject matter of the invention in an initial position, and

FIG. 3 shows the embodiment according to FIG. 2 in a partial braking position.

### DETAILED DESCRIPTION OF THE PREFERRED EMBODIMENTS

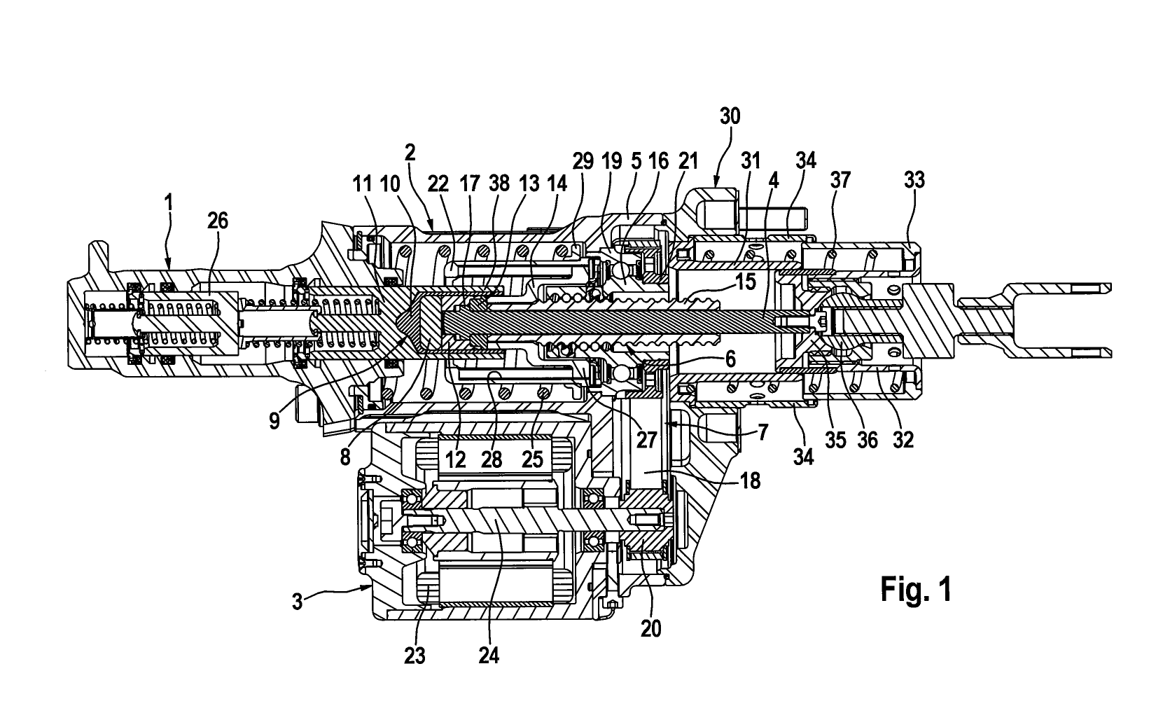

The brake actuating unit which is shown in FIG. 1 in an axial section comprises substantially a brake master cylinder 1, preferably a tandem master cylinder, a booster stage 2 which is connected in action terms in front of the brake master cylinder 1, and a drive unit 3 which serves to drive the booster stage 2 and is formed by an electric motor 23. A brake pedal (not shown) is provided for actuating the brake actuating unit according to aspects of the invention, to which brake pedal a piston rod 4 is coupled which is in force-transmitting connection with the first piston or primary piston 11 of the brake master cylinder 1. A second or secondary piston of the brake master cylinder is provided with the reference numeral 26, the two master cylinder pistons 11, 26 delimiting pressure spaces which are not denoted in greater detail and to which the wheel brakes of a motor vehicle are connected. The booster stage 2 is driven by means of a first step-down gear mechanism 6 which is configured as a ball screw drive, the threaded nut 16 of which is driven by the electric motor 23 with a second step-down gear mechanism 7 connected in between. The torque which is generated by the electric motor 23 is transmitted to the threaded nut 16 by means of a drive belt which bears the reference numeral 18 and which together with two pulley wheels 20, 21 forms a second step-down gear mechanism 7. Here, the first pulley wheel 20 is seated on an output shaft 24 of the electric motor 23, whereas the pulley wheel 21 of greater diameter is arranged at the right-hand end (in the drawing) of the previously mentioned threaded nut 16. Here, the first step-down gear mechanism 6 is preferably arranged in a booster housing 5, in which a radial bearing 19 is provided, in which the previously mentioned threaded nut 16 is mounted. The output element of the booster stage 2 is formed by the threaded spindle 15 of the ball screw drive 6.

Moreover, as can be gathered from FIG. 1, the two forces which act during the actuation of the brake actuating unit according to aspects of the invention, namely an actuating or input force which acts on the brake pedal and therefore on the piston rod 4 and a boosting force which is applied by the threaded spindle 15, are transmitted to the primary piston 11 by means of a force transmission module 9 which is received by an axial extension 38 of the primary piston 11, which axial extension 38 extends into the interior of the booster housing 5. The force transmission module 9 comprises substantially a cylindrical pressure sleeve 10, an elastic element 8 which is mounted in the latter, and a two-part guide ring 12, 13, in which the front end of the piston rod 4 is guided radially. For this purpose, the piston rod 4 has a radial guide shoulder or collar 17 in its region which lies within the guide ring 12. The elastic element 8 which is configured, for example, as an elastomeric disc serves to add the actuating force which is transmitted by the piston rod 4 and the boosting force which is transmitted by the threaded spindle 15, a force-transmitting connection existing between the end of the threaded spindle 15 and the guide ring 12, 13. It is particularly advantageous here if that end of the pressure sleeve 10 which is supported on the primary piston 11 is designed in the shape of a spherical cap.

In order to ensure satisfactory force transmission from the threaded spindle 15 to the guide ring 12, 13, the threaded spindle 15 is provided with a cup-shaped or bell-shaped anti-rotation sleeve 14, the edge of which of greater diameter forms a plurality of sliding blocks 27 which are guided displaceably in radial grooves 28 of a sliding guide sleeve 22 which is arranged coaxially with respect to the anti-rotation sleeve 14. The previously mentioned components, that is to say the pulley wheel 21 of the second step-down gear mechanism, the ball screw drive 6, the anti-rotation sleeve 14, the sliding guide sleeve 22 and the radial bearing 19, are previously configured here in such a way that they form a prefabricated assembly which can be handled with a single hand. Here, the sliding guide sleeve 22 carries a supporting ring 29, on which a compression or restoring spring 25 is supported which is arranged coaxially with respect to the abovementioned assembly and serves to return the threaded spindle 15 into its initial or rest position. As a result of these measures, the pressure which is regulated in the brake master cylinder 1 during the actuation is dissipated completely.

Finally, it can be gathered from the illustration according to FIG. 1 that the piston rod 4 is guided or mounted radially at its end which faces the brake pedal (not shown) in a guide housing 30 which is attached to the previously mentioned booster housing 5. The guide housing 30 is of multiple-piece configuration and has substantially an immovable cylindrical guide 31 and a movable guide sleeve 32 which is guided displaceably in the guide 31. A cylindrical guide part 33 which is guided in an outer guide sleeve 34 is connected to the guide sleeve 32. A bearing part 35 which is arranged in the guide sleeve 32 is connected fixedly to the latter, in which bearing part 35 the piston rod 4 is mounted by means of a spherical head 36. A piston-rod restoring spring 37 which reaches radially around the guide 31 and the guide sleeve 32 and moves the piston rod 4 into its initial position is supported on the guide part 33.

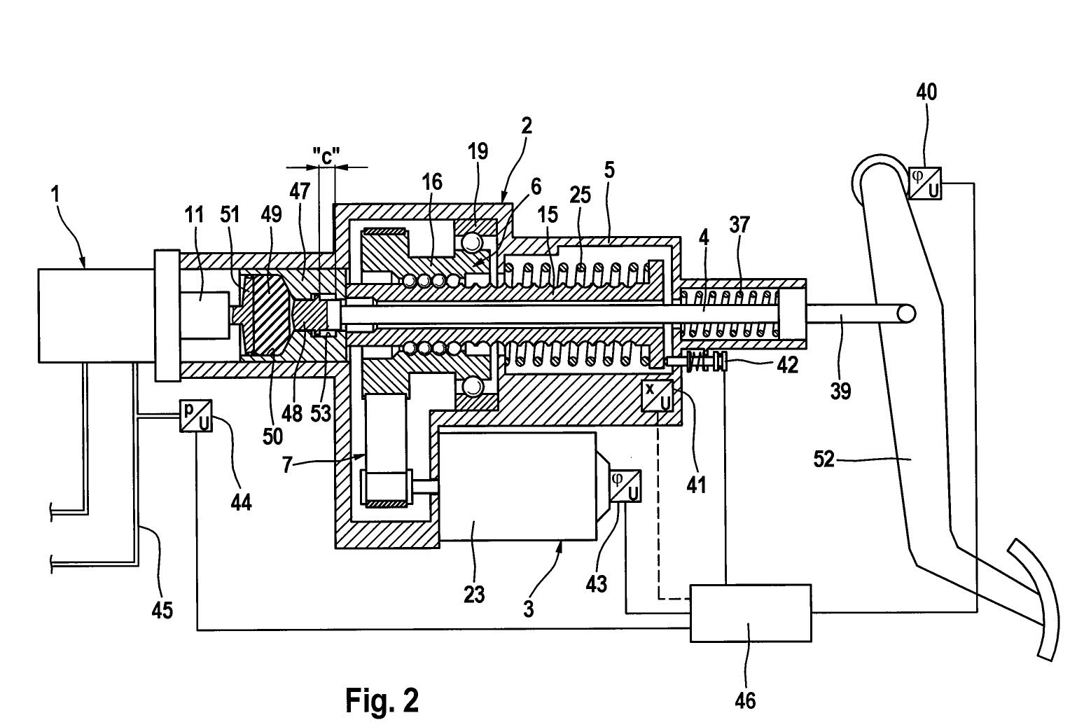

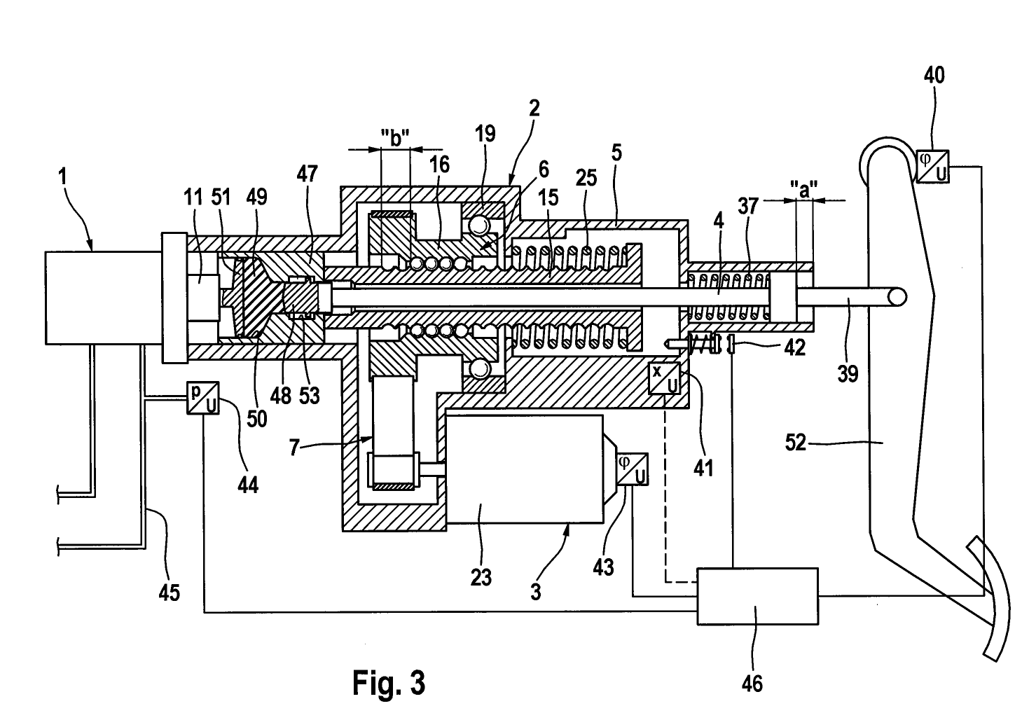

A plurality of sensors which are not shown in FIG. 1 are required for satisfactory operation of the above-described brake actuating unit according to aspects of the invention. These sensors and their method of operation are explained in the following description of the second embodiment of the present invention in conjunction with FIGS. 2 and 3.

A brake pedal 52, to which the piston rod 4 is connected by means of a force transmission rod 39, serves to actuate the second embodiment shown in FIGS. 2 and 3 of the subject matter of the invention. The actuating path “a” (see FIG. 3) of the piston rod 4 is detected indirectly by a rotary angle sensor 40, by way of which the (actuating) rotational movement of the brake pedal 38 is sensed. The travel of the threaded spindle 15 is determined by way of a second sensor or displacement sensor 41 which can be arranged in the booster housing 5, the initial position (shown in FIG. 1) of the threaded spindle 15 being monitored by an electric contact arrangement 42 which is configured as a break contact. The position of the rotor (not shown) of the electric motor 23 is detected by a rotor position sensor which is denoted in FIGS. 2 and 3 by the reference numeral 43. In order to monitor the hydraulic pressure which is regulated in the brake master cylinder 1 during the actuation of the brake pedal 52, a pressure sensor 44 is provided which is connected to a first brake circuit 45 which is indicated merely diagrammatically and is connected to the first or primary pressure space of the brake master cylinder 1, which first or primary pressure space is mentioned in conjunction with FIG. 1. The output signals of the said sensors are fed via corresponding signal lines to an electronic control and regulating unit 46 which generates actuating signals for the electric motor 23 according to an algorithm which is stored in the said control and regulating unit 46.

Furthermore, it can be gathered from FIGS. 2 and 3 that the boosting force which is applied by the threaded spindle 15 is transmitted to a force transmission sleeve 47 which is guided displaceably in the booster housing 5. A transmitter chamber 50 which is filled with a suitable force transmission medium 49 is formed in the interior of the force transmission sleeve 47. A pasty pressure-resistant compound which is not prone to gap extrusion can be used as the force transmission medium 49. As an alternative, a plurality of balls of small diameter can be used. The transmitter chamber 50 is delimited firstly by a head flange of a push rod 51 and secondly by the end face of a reaction piston 48 which is guided in the force transmission sleeve 47. Whereas the push rod 51 is supported on the primary piston 11 of the brake master cylinder 1, the previously mentioned piston rod 4 is supported on the reaction piston 48, as a result of which the actuating force which is introduced at the brake pedal 38 is transmitted to the force transmission medium 49. The reaction piston 48 which, as a result of its construction, transmits a reaction force which results from the boosting force to the piston rod 4 and therefore to the brake pedal 52 during the actuation makes a relative travel “c” of the push rod 51 possible with respect to the force transmission sleeve 47, which relative travel “c” is defined by the width of a radial groove 53 which is provided for this purpose in the force transmission sleeve 47. The reference sign “b” denotes the travel which is covered by the threaded spindle 15 during the actuation (FIG. 3).

1.-23. (canceled)

24. A brake actuating unit comprising:
a brake master cylinder which is configured to be actuated by a brake pedal and to which wheel brakes of a motor vehicle are connected,
a booster stage which is connected in front of the brake master cylinder,
a drive unit for driving the booster stage, which drive unit is formed by an electric motor, a piston rod for transmitting an actuating force being provided between the brake pedal and a primary piston of the brake master cylinder,
wherein the booster stage is arranged in a booster housing and includes a first step-down gear mechanism which is formed by a ball screw drive, wherein a threaded nut of the ball screw drive is driven by the electric motor via a second step-down gear mechanism and wherein a threaded spindle of the ball screw drive transmits a boosting force which is generated by the booster stage to the primary piston,
wherein a transmission of the actuating force and the boosting force to the primary piston takes place by a force transmission module which has at least one elastic element and is arranged in the primary piston.

25. Brake actuating unit according to claim 24, wherein the force transmission module has a pressure sleeve which receives both the elastic element and also at least one guide ring which guides the piston rod.

26. Brake actuating unit according to claim 25, wherein the piston rod is provided with a radial guide collar in a region which lies within the guide ring.

27. Brake actuating unit according to claim 24, wherein the threaded spindle is provided with an anti-rotation sleeve which interacts with a sliding guide sleeve.

28. Brake actuating unit according to claim 27, wherein the sliding guide sleeve forms a stop element for the anti-rotation sleeve.

29. Brake actuating unit according to claim 24, wherein the elastic element is formed by an elastomeric disc.

30. Brake actuating unit according to claim 27, wherein the threaded nut of the ball screw drive forms a bearing inner ring of a radial bearing, which bearing inner ring carries a first pulley wheel which forms a constituent part of the second step-down gear mechanism.

31. Brake actuating unit according to claim 30, wherein the second step-down gear mechanism is formed by the pulley wheel, a second pulley wheel of smaller diameter which is driven by the electric motor, and a drive belt which is tensioned between the pulley wheel and the second pulley.

32. Brake actuating unit according to claim 30, wherein the first pulley wheel, the radial bearing, the ball screw drive, the anti-rotation sleeve and the sliding guide sleeve form a prefabricated assembly which is configured to be handled with a single hand and is configured to be installed into a booster housing.

33. Brake actuating unit according to claim 32, wherein a restoring spring which serves to return the threaded spindle into its initial position is provided in the booster housing coaxially with respect to the assembly.

34. Brake actuating unit according to claim 24, wherein a guide housing which serves to guide the piston rod radially is attached to the booster housing.

35. Brake actuating unit according to claim 34, wherein an immovable, cylindrical guide is provided in the guide housing, in which cylindrical guide an inner guide sleeve is guided, in which the piston rod is mounted by a spherical head.

36. Brake actuating unit according to claim 35, wherein the spherical head is mounted in a bearing part which is arranged in the inner guide sleeve and is connected fixedly to the inner guide sleeve.

37. Brake actuating unit according to claim 34, wherein a piston-rod restoring spring which reaches radially around both the cylindrical guide and the inner guide sleeve is arranged in the guide housing.

38. Brake actuating unit according to claim 24, wherein the transmission of the actuating force and the boosting force to the primary piston takes place by a force transmission sleeve which is mounted displaceably in the booster housing and on which the threaded spindle is supported, in which a transmitter piston is guided which is supported on the piston rod and delimits a transmitter chamber which is filled with a force transmission medium and is delimited secondly by a push rod which is supported on the primary piston of the brake master cylinder.

39. Brake actuating unit according to claim 38, wherein the force transmission medium is formed by a pasty pressure-resistant compound which is not prone to gap extrusion.

40. Brake actuating unit according to claim 39, wherein the force transmission medium is formed by a plurality of small balls.

41. Brake actuating unit according to claim 24 further comprising at least one sensor device for detecting the actuating travel of the piston rod.

42. Brake actuating unit according to claim 24 further comprising a sensor device for detecting movement of the threaded spindle.

43. Brake actuating unit according to claim 24 further comprising a sensor device for detecting a rotor position of the electric motor.

44. Brake actuating unit according to claim 24 further comprising a sensor device for detecting a hydraulic pressure which is regulated in the brake master cylinder.

45. Brake actuating unit according to claim 42, wherein the sensor device is configured as a rotary angle sensor for detecting an actuating travel of the brake pedal.

46. Brake actuating unit according to claim 41 further comprising an electronic control and regulating unit, to which output signals of at least one of the sensor devices are fed and which generates actuating signals for the electric motor.
